(19) United States
(12) Patent Application Publication
(10) Pub. No.: US 2023/0190430 A1
(43) Pub. Date: Jun. 22, 2023

(54) SALIVA EJECTOR HAVING A DESIGN ELEMENT

(71) Applicant: Stoma Ventures, LLC, Chesterfield, MO (US)

(72) Inventor: Charles Thomas, Vero Beach, FL (US)

(21) Appl. No.: 17/556,701

(22) Filed: Dec. 20, 2021

(51) Int. Cl. A61C 17/06

(52) U.S. Cl. CPC A61C 17/06; A61C 2203/00

(57) ABSTRACT

A saliva ejector has a body having an exterior surface, a valve receiving end, a tip, a lumen formed between the valve receiving end and the tip, and a design element extending out from the exterior surface.

### BACKGROUND

This disclosure relates to a saliva ejector or an evacuator for use with a dental valve and more particularly to saliva ejector having a design element.

During a dental procedure it is important to be able to remove saliva, blood, tooth fragments, metals, and other debris from the mouth of a patient. Removal of this matter allows a dentist to be able to perform a procedure in an unobstructed manner. Various systems or devices have been developed to remove liquid and solid materials from a mouth during a dental procedure. One device that is capable of removing saliva is known as a saliva ejector, tip, or straw. A saliva ejector typically comprises a plastic flexible tube, straw, or tip for placement in the mouth of a patient. The plastic flexible tube may have a wire embedded therein to allow the tube to be bent to a desired position. The saliva ejector tip is connected to a dental valve and the valve is connected to a hose or to a tailpiece that is connected to the hose. The hose is connected to a source of vacuum. In this manner, saliva is passed through the ejector tip, the valve, the tailpiece, and the hose to be disposed of in a sanitary manner. Once the procedure is completed, the ejector tip should be discarded and the valve should be replaced. The used valve should also be sterilized by autoclaving to be used again. Although it is suggested to autoclave the valve after use, it is known that autoclaving is hardly ever done. Another device that is capable of removing solid materials is a high volume evacuator system, tip, or straw. A high volume evacuator system generally consists of a tube, straw, or tip that may be inserted into a mouth of a patient with the tube connected to a dental valve which is connected to a tailpiece with the tailpiece being connected to a hose or tubing that is in fluid communication with a source of vacuum. Again, in this manner, debris may be removed from the mouth of the patient. After the dental procedure, the tip is disposed of and the valve should be replaced. The used valve should also be sterilized by autoclaving to be used again. However, although it is suggested to sterilize the valve after use, it is known that this suggested procedure is hardly ever followed. As can be appreciated, the saliva ejector and the high volume evacuator are used to remove liquids and debris from a mouth of a patient to prevent a patient from swallowing or aspirating liquids and debris produced during a dental procedure.

As indicated, the saliva ejector dental valve or the high volume evacuator dental valve is connected to one end of the dental valve. The dental valve has another end that is mated to the tailpiece or the hosing. The saliva ejector valve and the high volume evacuator valve each has a valve body having a passage or a lumen and a valve sealing member. The valve sealing member has an opening that may be aligned with the passage to allow saliva and other material to pass when the valve sealing member is in an opened position. When the valve sealing member is in a closed position, the source of vacuum is cut off by the valve sealing member blocking the passage through the valve body. In this manner, the saliva ejector valve and the high volume evacuator valve may be opened or closed.

One problem associated with the use of saliva ejector tips is that the tips are utilitarian devices and present a rather drab or dull appearance to a patient. There are numerous opportunities for presenting a fanciful design, including various fanciful or design elements, to a patient.

Therefore, it would be desirable to have a saliva ejector that is capable of presenting a design to a patient. It would be further advantageous to provide a saliva ejector that includes a fanciful feature or device to be enjoyed by a child during a dental operation. Further, it would be beneficial to provide a saliva ejector that is disposable for a single use to prevent contamination.

### BRIEF SUMMARY

In one form of the present disclosure, a saliva ejector comprises a body having an exterior surface, a valve receiving end, a tip, a lumen formed between the valve receiving end and the tip, and a design element extending out from the exterior surface.

In another form of the present disclosure, a saliva ejector comprises a body having an exterior surface, a valve receiving end, a tip, a lumen formed between the valve receiving end and the tip, a design element extending out of the exterior surface, the design element having a disc shape.

In yet another form of the present disclosure, a saliva ejector comprises a body having an exterior surface, a valve receiving end, a tip, a lumen formed between the valve receiving end and the tip, a design element extending out of the exterior surface, the design element comprising a shape.

The present disclosure provides a saliva ejector which is of simple construction and design and which can be easily employed with highly reliable results.

The present disclosure provides a saliva ejector that is easy to install on a dental valve to be used during a dental procedure.

The present disclosure provides a saliva ejector that is small, lightweight, easy to handle, easy to install, and easy to use.

The present disclosure is also directed to a saliva ejector that does not require any special tools to attach the ejector to a dental valve.

The present disclosure is related to a saliva ejector saliva ejector that can be mated to a disposable dental valve device for use during a dental procedure.

The present disclosure provides a saliva ejector that may be disposable for a single use or a single dental operation.

The present disclosure is also directed to a saliva ejector that is made of a lightweight material such as plastic, polyethylene, and high density polyethylene or any other similar material so that the ejector may be disposable after a single use.

The present disclosure is related to a saliva ejector that may be used to allow dental valves of various sizes to be easily mated to the ejector.

The present disclosure also provides a saliva ejector that may have incorporated therein or coated thereon an antimicrobial agent or chemical to further protect against cross-contamination when using the ejector.

The present disclosure is directed to a saliva ejector that includes a fanciful element to pacify or amuse a child during a dental procedure.

These and other advantages of the present disclosure will become apparent after considering the following detailed specification in conjunction with the accompanying drawings, wherein:

### BRIEF DESCRIPTION OF THE DRAWINGS

FIG. 1 is a side view of a saliva ejector constructed according to the present disclosure;

FIG. 2 is a front view of the saliva ejector constructed according to the present disclosure;

FIG. 3 is a front view of another embodiment of a saliva ejector constructed according to the present disclosure; and

FIG. 4 is a perspective view of the saliva ejector connected to a dental valve.

### DETAILED DESCRIPTION OF A PREFERRED EMBODIMENT

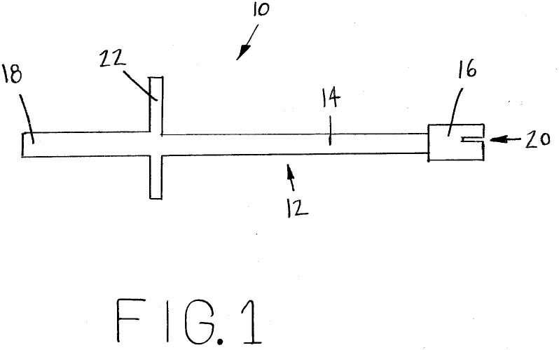

Referring now to the drawings, wherein like numbers refer to like items, number 10 identifies a saliva ejector constructed according to the present disclosure. With reference now to FIG. 1, the saliva ejector 10 comprises a body 12 having an exterior surface 14, a tip 16, a valve receiving end 18, and a lumen or channel 20 formed between the tip 16 and the valve receiving end 18. The channel 20 allows any liquid, saliva, blood, tooth fragments, or other debris to flow there through. The saliva ejector 10 also has a fanciful or design element 22 extending out of the exterior surface 14. Although the design element 22 is shown being integral with the exterior surface 14, it is possible that the design element 22 may be placed over the exterior surface 14 and extend out therefrom. The saliva ejector 10 may be formed of any suitable material so that the saliva ejector 10 is disposable.

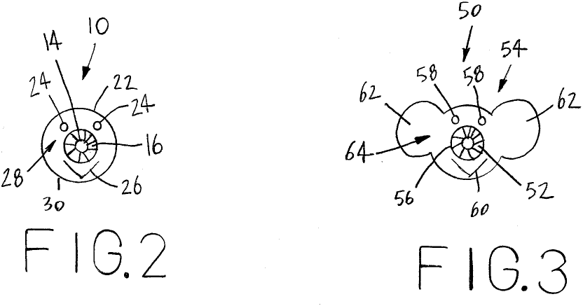

FIG. 2 illustrates a front view of the saliva ejector 10. The ejector 10 has the tip 16 and the design element 22 extending out of the exterior surface 14. The design element 22 has a pair of eyes 24 and a mouth 26 to form or present a face 28 for a patient. The tip 16 may present a nose feature to the patient. The design element 22 may be a disc 30 that may be formed as part of manufacturing the saliva ejector 10. Although a disc 30 is shown it is also possible and contemplated that the design element 22 may take on any other form or shape that extends out from the exterior surface 14. As previously indicated, it is also contemplated that the disc 30 may be placed over the exterior surface 14 and extend out from the exterior surface 14.

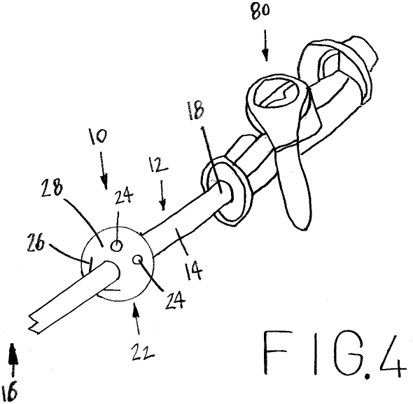

With reference now to FIG. 3, another embodiment of a saliva ejector 50 constructed according to the present disclosure is shown. The saliva ejector 50 has a tip 52 and a design element 54 extending out of an exterior surface 56 of the saliva ejector 50. The design element 54 has a pair of eyes 58, a mouth 60, and a pair of ears 62. The eyes 58, the mouth 60, and the ears 62 present a face 64 to a patient. The tip 52 may represent a nose to a patient.

FIG. 4 depicts the saliva ejector 10 being connected to a dental valve device 80. Although not shown, the dental valve device 80 may also be connected to a tailpiece or a suction hose. The saliva ejector 10 comprises the body 12 having the exterior surface 14, the tip 16, and the valve receiving end 18. The saliva ejector 10 also has a fanciful or design element 22 extending out of the exterior surface 14. The design element 22 has a pair of eyes 24 and a mouth 26 to form or present a face 28 for a patient. The tip 16 may present a nose feature to the patient.

In operation of the saliva ejector 10, the saliva ejector 10 may be initially inserted into the dental valve 80 to secure the ejector 10 to the dental valve device 80. As is known, a tailpiece (not shown) is connected to a hose (not shown) and the hose is connected to a suction system (also not shown). The ejector 10 may then be placed in a mouth of a dental patient during a procedure to remove debris or fluids from the mouth. As can be appreciated, the design element 22 displayed to the patient may pacify a young patient who may be apprehensive about a dental procedure. Once the dental valve 80 is opened, air is allowed to flow through the ejector 10, the dental valve 80, the tailpiece, the hose, and into the suction system for disposal. When suction is not needed during a dental procedure, the dental valve 80 is closed. Further, once a dental procedure has been completed, the dental valve 80 is closed, removed from the tailpiece and the ejector 10 and the dental valve device 80 are discarded. In this manner the saliva ejector 10 is a disposable or one time use device. As can be appreciated, to begin a new dental procedure a new ejector 10 and a new dental valve device 80 may be inserted into the tailpiece.

The saliva ejectors 10 and 50 may be formed of any suitable material such as metal, plastic, polyethylene, high density polyethylene, or any other material. Any suitable material may be used to construct the ejectors 10 and 50 so that the ejectors 10 and 50 may withstand use in a dental operation or procedure. Further, it is also possible and contemplated to incorporate an antimicrobial agent or chemical in the ejectors 10 and 50 or to provide a coating of an antimicrobial agent on the ejectors 10 and 50 to further prevent cross-contamination when using the ejectors 10 and 50 during a dental operation or procedure.

From all that has been said, it will be clear that there has thus been shown and described herein a saliva ejector which fulfills the various advantages sought therefore. It will become apparent to those skilled in the art, however, that many changes, modifications, variations, and other uses and applications of the subject saliva ejector are possible and contemplated. All changes, modifications, variations, and other uses and applications which do not depart from the spirit and scope of the disclosure are deemed to be covered by the disclosure, which is limited only by the claims which follow.

What is claimed is:

1. A saliva ejector comprising:
a body having an exterior surface, a valve receiving end, a tip, a lumen formed between the valve receiving end and the tip, and a design element extending out of the exterior surface.

2. The saliva ejector of claim 1 wherein the design element comprises an eye.

3. The saliva ejector of claim 1 wherein the design element comprises an ear.

4. The saliva ejector of claim 1 wherein the design element comprises a face.

5. The saliva ejector of claim 1 wherein the design element comprises a pair of eyes and a pair of ears.

6. The saliva ejector of claim 1 wherein the design element comprises a pair of eyes, a pair of ears, with the pair of eyes and the pair of ears forming a face.

7. The saliva ejector of claim 1 wherein the design element comprises a pair of eyes and a mouth with the pair of eyes and the mouth forming a face.

8. A saliva ejector comprising:
a body having an exterior surface, a valve receiving end, a tip, a lumen formed between the valve receiving end and the tip, a design element extending out of the exterior surface, the design element having a disc shape.

9. The saliva ejector of claim 8 wherein the design element comprises an eye.

10. The saliva ejector of claim 8 wherein the design element comprises an ear.

11. The saliva ejector of claim 8 wherein the design element comprises a face.

12. The saliva ejector of claim 8 wherein the design element comprises a pair of eyes and a pair of ears.

13. The saliva ejector of claim 8 wherein the design element comprises a pair of eyes, a pair of ears, with the pair of eyes and the pair of ears forming a face.

14. The saliva ejector of claim 8 wherein the design element comprises a pair of eyes and a mouth with the pair of eyes and the mouth forming a face.

15. A saliva ejector comprising:
a body having an exterior surface, a valve receiving end, a tip, a lumen formed between the valve receiving end and the tip, a design element extending out of the exterior surface, the design element comprising a shape.

16. The saliva ejector of claim 15 wherein the design element comprises an eye.

17. The saliva ejector of claim 15 wherein the design element comprises an ear.

18. The saliva ejector of claim 15 wherein the design element comprises a face.

19. The saliva ejector of claim 15 wherein the design element comprises a pair of eyes, a pair of ears, with the pair of eyes and the pair of ears forming a face.

20. The saliva ejector of claim 15 wherein the design element comprises a pair of eyes and a mouth with the pair of eyes and the mouth forming a face.
